(19) United States
(12) Patent Application Publication
(10) Pub. No.: US 2008/0070201 A1
(43) Pub. Date: Mar. 20, 2008

(54) BRAILLE BLOCK

(76) Inventors: Young Tag Kwon, Iksan (KR); Ji Ho Kang, Gunsan (KR)

Correspondence Address: SHERR & NOURSE, PLLC, 620 HERNDON PARKWAY, SUITE 200, HERNDON, VA, 20170, US

(21) Appl. No.: 11/854,385

(22) Filed: Sep. 12, 2007

(30) Foreign Application Priority Data
Sep. 14, 2006 (KR) 10-2006-0089256

(51) Int. Cl. G09B 21/00

(52) U.S. Cl. 434/113

(57) ABSTRACT

A Braille block for use by the blind is disclosed. The Braille block includes a block body having a plurality of core holes, and a plurality of Braille cores selectively inserted into the core holes to transliterate desired letters into Braille characters. The Braille cores include short Braille cores and long Braille cores. When the long Braille cores are inserted into the core holes, they project from the surface of the block body. However, when the short Braille cores are inserted into the core holes, they do not project from the surface of the block body. Thus, the abrasion on the Braille blocks is concentrated on the Braille cores, so that the abraded Braille blocks can be renewed by changing only the abraded Braille cores with new ones. Further, when an existing Braille block breaks, only the broken Braille block can be changed with a new one.

### BACKGROUND OF THE INVENTION

1. Field of the Invention

The present invention relates, in general, to Braille blocks for use by the blind and, more particularly, to a Braille block, which can be easily renewed when it is abraded.

2. Description of the Related Art

Generally, the Braille block is a block devised for use by the blind on which embossments are formed to allow the blind to recognize the presence or the rough shapes of the embossments by touching them with the soles of their feet or a stick while walking along a path. Thus, the Braille blocks are used as safety materials for guiding the blind along the right path and guiding the blind in a direction to a desired place, thus allowing the blind to safely walk along the path.

Generally, the conventional Braille system for use by the blind is based on a six-dot Braille system, in which combinations of six dots represent one consonant, one vowel or one Arabic numeral in Braille characters. The six-dot Braille system comprises three dots along a horizontal axis and two dots along a vertical axis.

In the related art, to guide the blind along the right path or in a direction to a desired place, dotted Braille embossments or linear Braille embossments made of urethane, plastic, alloy, such as brass or bronze, aluminum or stainless steel are proposed. To fix the dotted Braille embossments or the linear Braille embossments to desired locations, two types of techniques, which are an embedding technique and a bonding technique, are used. In the embedding technique, the Braille embossments are configured to have respective embedment parts while a plurality of embedment holes is formed in the desired locations. Thus, the Braille embossments are embedded in the embedment holes. In the bonding technique, the Braille embossments are bonded to the desired locations using a bonding agent or bonding tape without forming the embedment parts on the Braille embossments or forming the embedment holes in the desired locations.

However, the bonding technique of fixing the Braille embossments to the desired locations is problematic in that moisture or rainwater may easily infiltrate into the bonded junction and reduce the bonding strength of the bonded junction. Further, the bonded Braille embossments may be easily removed from the locations by lateral impacts. Thus, to fix the Braille embossments to the desired locations in the related art, the embedding technique is preferentially used, rather than the bonding technique.

However, in the embedding technique, the dotted Braille embossments are bonded to the desired locations using a bonding agent prior to being embedded in the locations, so that the fixing strength of the embossments in the locations can be increased by the bonding force of the bonding agent. However, the bonding agent may easily leak from the bonded junction, thus spoiling the appearance of the arrangement of the embossments and reducing work efficiency during the process of embedding the embossments in the locations.

In order to solve the problems, a Braille block, which is made of urethane or plastic and is integrated with Braille embossments, is proposed. However, the Braille block having the Braille embossments is problematic in that the embossments projecting from the surface of the block may be easily abraded by the shoe soles of pedestrians or by the wheels of vehicles.

FIG. 1 is a view illustrating the arrangement of conventional Braille blocks laid on a sidewalk. As shown in FIG. 1, the arrangement of the conventional Braille blocks may be formed by the combination of a plurality of linear Braille blocks 22, which have linear Braille embossments and are linearly arranged to guide the blind with a stick in a direction to a desired place, and a plurality of dotted Braille block 21, which have dotted Braille embossments and are placed together to form a crossing area. When a blind person walks with a stick along a path formed by the linear arrangement of the linear Braille blocks 22 and reaches the crossing area formed by the dotted Braille blocks 21, the blind person stops walking on the crossing area temporarily and walks again along another path formed by the linear Braille blocks 21 while remembering the route.

However, when the blind person on the crossing area formed by the dotted Braille blocks 22 forgets the direction to a desired place, the determination of the direction is beyond the ability of the blind person, so that the blind person must ask a passer-by the way, thus suffering inconvenience.

### SUMMARY OF THE INVENTION

Accordingly, the present invention has been made keeping in mind the above problems occurring in the related art, and provides a Braille block, which can be easily renewed when it is abraded.

Further, the present invention provides a Braille block, which is laid on a sidewalk and guides the blind along the right path.

In order to achieve the above features, according to one aspect of the present invention, there is provided a Braille block, comprising: a block body having a plurality of core holes; and a plurality of Braille cores selectively inserted into the core holes of the block body to transliterate desired letters into Braille characters, wherein the Braille cores comprise a short Braille core and a long Braille core, such that, when the long Braille core is inserted into one of the core holes of the block body, the long Braille core projects from the surface of the block body and, when the short Braille core is inserted into one of the core holes of the block body, the short Braille core does not project from the surface of the block body.

Further, in the present invention, the length of the short Braille core is preferably equal to the depth of the core holes formed in the block body, and the upper end of the long Braille core is preferably chamfered or rounded.

Further, in the present invention, the Braille block may be laid on a sidewalk, thus being used as means for guiding the blind to a place or helping the blind stay on course.

The Braille block according to the present invention preferably further comprises means for giving directions to people without disabilities on a side of the surface of the Braille block, thus allowing people without disabilities to recognize the meaning of the Braille characters transliterated on the Braille block.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating the arrangement of conventional Braille blocks laid on a sidewalk;

FIG. 2 is an exploded perspective view of a Braille block according to an embodiment of the present invention;

FIGS. 3A, 3B and 3C are a perspective view, a plan view and a front view of the Braille block of FIG. 2, with long and short Braille cores installed in the core holes of the block body of the Braille block;

FIG. 3D is a front view of a Braille block according to another embodiment of the present invention;

FIGS. 4A, 4B and 4C illustrate the arrangements of the Braille blocks laid on a sidewalk according to embodiments of the present invention; and

FIG. 4D illustrates the arrangement of the Braille blocks with English words representing the directions to places, which correspond to Korean letters representing the directions to the places shown in FIG. 4C.

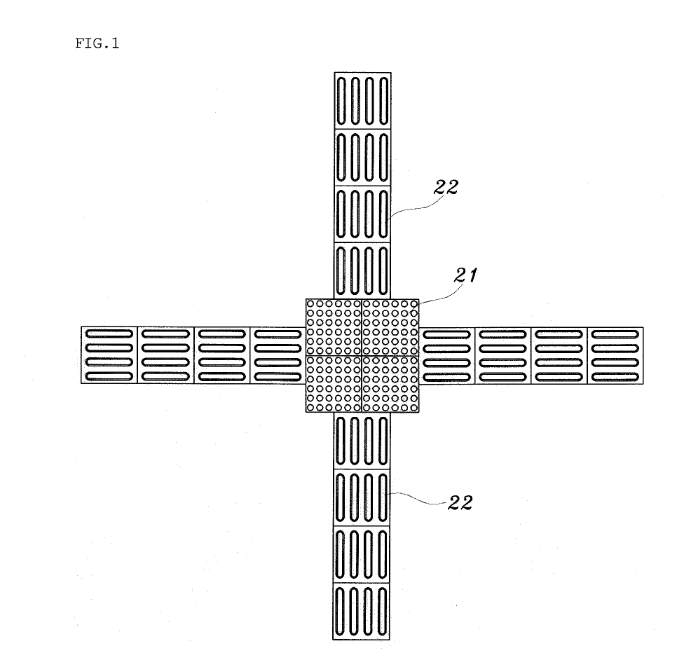

### DETAILED DESCRIPTION OF THE INVENTION

Reference will now be made in greater detail to embodiments of the invention, examples of which are illustrated in the accompanying drawings. Wherever possible, the same reference numerals will be used throughout the drawings and the description to refer to the same or like parts.

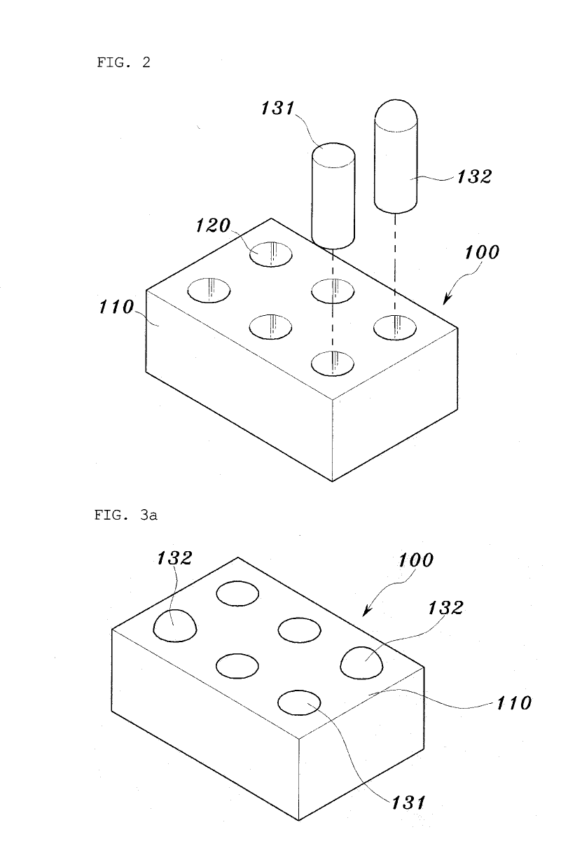

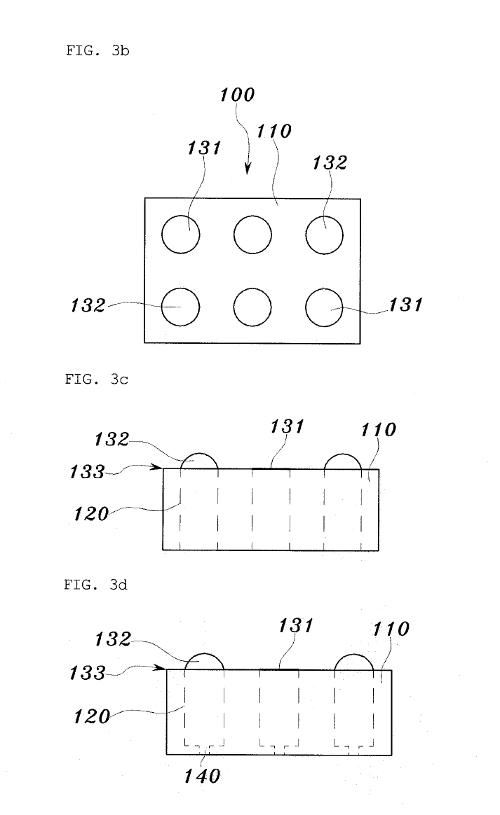

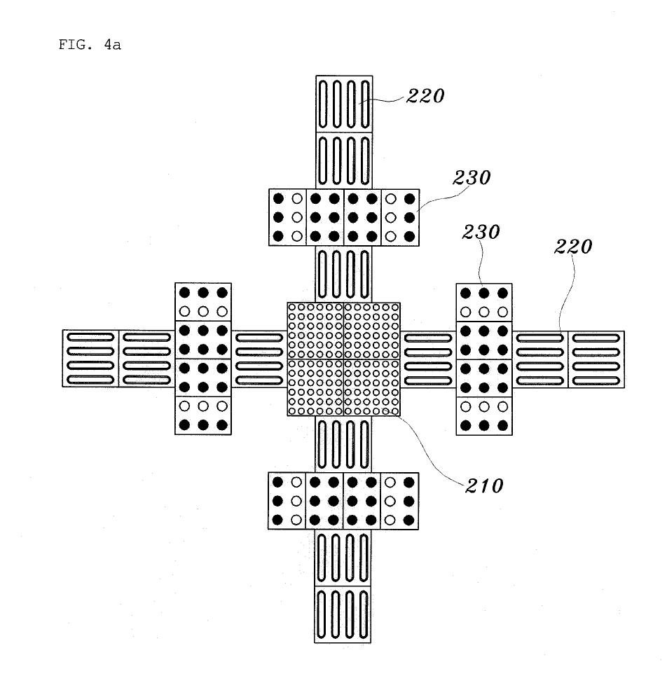

FIG. 2 is an exploded perspective view of a Braille block according to an embodiment of the present invention. FIGS. 3A, 3B and 3C are a perspective view, a plan view and a front view of the Braille block of FIG. 2, with long and short Braille cores installed in the core holes of the block body of the Braille block.

As show in FIGS. 2, 3A, 3B and 3C, the Braille block 100 according to the present invention comprises a block body 110 and a plurality of Braille cores 131 and 132.

The block body 110 has a structure that is suitable for being embedded in or being laid on a sidewalk, and preferably has a flat cuboidal shape.

The block body 110 is provided with a plurality of core holes. The number of core holes is not specifically limited, but is preferably set to six. This is because six is the minimum number required to represent one consonant, one vowel or one Arabic numeral into Braille characters, as described above.

Further, each of the core holes is perforated from the top to the bottom and preferably has a cylindrical shape.

The Braille cores 131 and 132 are inserted into the core holes so that each of the Braille cores 131 and 132 has a longitudinal shape corresponding to the shape of the core holes. Each of the Braille cores 131 and 132 preferably has a cylindrical shape.

Further, the depth of the core holes is preferably determined such that the Braille cores 131 and 132 can be prevented from being easily removed from the core holes.

The Braille cores are classified into two types according to the length thereof. In other words, the Braille cores comprise a plurality of short Braille cores 131 and a plurality of long Braille cores 132. In the description, the technical terms “long” and “short” are merely used to define the difference in the length between the two types of Braille cores 131 and 132. That is, the long Braille cores 132 are longer than the short Braille cores 131.

In the present invention, the long Braille cores 132 and the short Braille cores 131 are selectively inserted into the core holes of the block body 110 so as to transliterate desired letters in Braille characters.

The length of each of the short Braille cores 131 is preferably set so that it is equal to or less than the depth of the core holes of the block body 110. Thus, when the short Braille cores 131 of the present invention are inserted into the core holes of the block body 110, as shown in FIGS. 3A through 3C, the short Braille cores 131 do not project from the upper surface 133 of the block body 110.

In the meantime, the length of the long Braille cores 132 is set so that it is greater than that of the short Braille cores 131. Thus, when the long Braille cores 132 are inserted into the core holes of the block body 110, as shown in FIG. 3, the long Braille cores 132 project from the upper surface 133 of the block body 110.

In the present invention, the upper surfaces of the short Braille cores 131 are preferably formed as flat surfaces, while the upper surfaces of the long Braille cores 132 are preferably chamfered or rounded.

Further, in the present invention, after the Braille cores 131 and 132 are inserted into the core holes of the block body 110, the gaps between the core holes and the cores 131 and 132 are preferably filled with a filling material, such as sand.

Further, in the present invention, to easily insert and remove the Braille cores 131 and 132 into and from the core holes and to protect the block body 110 and the Braille cores 131 and 132 from being easily abraded, the block body 110 and the Braille cores 131 and 132 are preferably made of stone.

FIG. 3D is a front view of a Braille block according to another embodiment of the present invention;

As shown in FIG. 3D, the Braille block 100 according to the present invention may further include a drain hole 140, which has a diameter smaller than that of each of the core holes 120 formed in the block body 110.

The drain holes 140 are formed in the block body 110 at locations below the respective core holes 120 such that the drain holes 140 communicate with the respective core holes 120.

Due to the above-mentioned drain holes 140, it is possible to support the Braille cores 131 and 132 on the holed steps in the core holes 120 and to prevent the cores 131 and 132 from moving further downwards in the core holes 120. Second, the drain holes 140 drain rain water therefrom, thus preventing water from staying in the core holes 120.

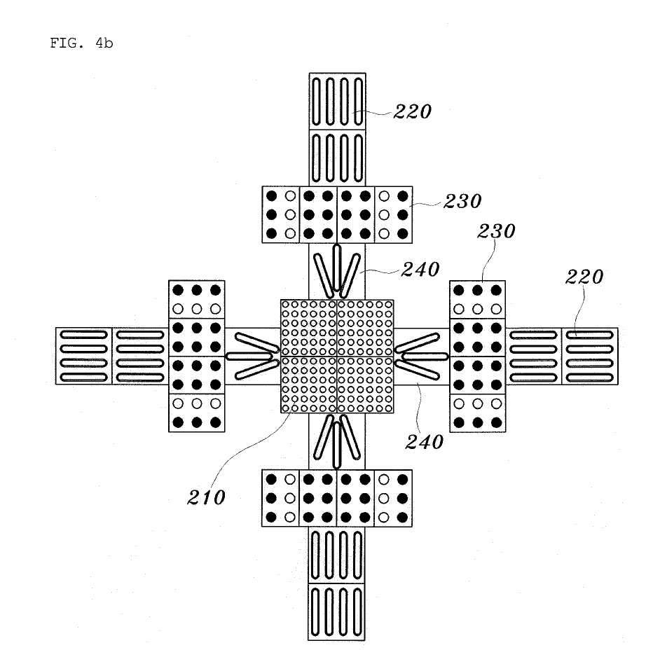

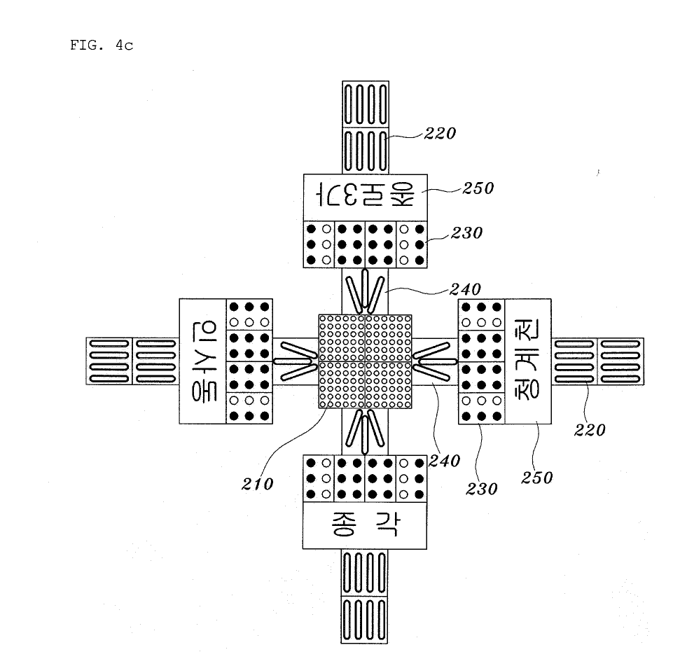

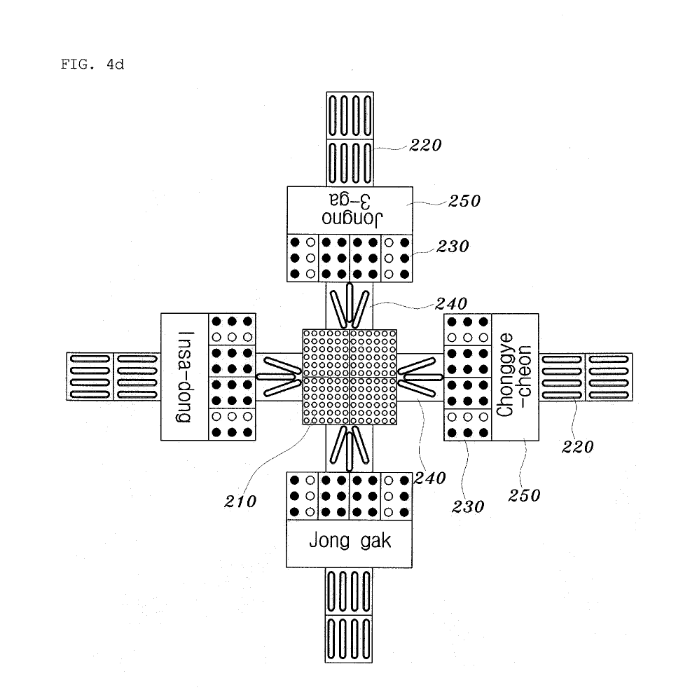

FIGS. 4A through 4C illustrate the arrangements of Braille blocks laid on a sidewalk according to embodiments of the present invention. FIG. 4D illustrates the arrangement of the Braille blocks with English words indicating the directions to places, which correspond to Korean letters representing the directions to the places shown in FIG. 4C.

As shown in FIG. 4A, when a blind person walks with a stick along linear Braille blocks 220, each having linear Braille embossments, the blind reaches a crossing area formed by dotted Braille blocks 210 each having dotted Braille embossments.

In FIG. 4A, the solid dots () denote the core holes 120 filled with the long Braille cores 132, while the hollow dots (°) denote the core holes 120 filled with the short Braille cores 131.

In the embodiment of the present invention, a plurality of guidance Braille blocks 230 for guiding the blind along a desired path is installed on respective locations spaced apart from the crossing area, formed by the dotted Braille blocks 210, by predetermined distances, thus guiding the blind in various directions to various places (for example, four directions to four places).

Each of the guidance Braille blocks 230 has indicated thereon the name of a respective place or building.

Of course, each of the guidance Braille blocks 230 may be formed by linearly arranging the Braille blocks 100 of FIGS. 2 and 3A through 3D.

The present invention may further include direction Braille blocks 240 representing the directions to the crossing area.

The direction Braille marks represented on the direction Braille blocks 240 may be formed in a variety of patterns. In the embodiment of the present invention, the direction Braille marks of the direction Braille blocks 240 are configured as arrow marks, as shown in FIG. 4B.

When the direction Braille marks of the direction Braille blocks 240 are configured as the arrow marks, as described above, it is easy for people without disabilities to recognize the directions to places.

Further, the present invention preferably further comprises means for showing people without disabilities the way on a side of the surface of each of the guidance Braille blocks 230, thus allowing people without disabilities to recognize the meaning of the Braille characters transliterated on the Braille blocks 230 (see FIGS. 4C and 4D).

As described above, the Braille block according to the present invention provides the following advantages.

First, the Braille block according to the present invention may be configured to be embedded in the sidewalk, so that it is easy to lay or remove the Braille blocks on or from the sidewalk.

Second, abrasion on the Braille blocks is mainly concentrated on the Braille cores, so that, when the abrasion on the Braille blocks exceeds a predetermined level, the abraded Braille blocks may be renewed by changing only the abraded Braille cores with new ones. Further, when an existing Braille block breaks, it is possible to change only the broken Braille block with a new one.

Third, when it is required to change the contents of the Braille characters represented on the Braille blocks, the change of the contents can be achieved by changing only the Braille cores.

Thus, the present invention reduces the maintenance cost of the Braille blocks.

Further, in the present invention, the drain holes are formed in the Braille block so as to communicate with respective core holes. Thus, the drain holes prevent water from remaining in the core holes of the Braille block.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A Braille block, comprising:
a block body having a plurality of core holes; and
a plurality of Braille cores selectively inserted into the core holes of the block body to transliterate desired letters in Braille characters, wherein
the Braille cores comprise a short Braille core and a long Braille core, such that, when the long Braille core is inserted into one of the core holes of the block body, the long Braille core projects from a surface of the block body and, when the short Braille core is inserted into one of the core holes of the block body, the short Braille core does not project from the surface of the block body.

2. The Braille block as set forth in claim 1, wherein the short Braille core has a length equal to a depth of each of the core holes formed in the block body and the long Braille core is chamfered or rounded on an upper end thereof.

3. The Braille block as set forth in claim 1, further comprising:
a drain hole formed in the block body at a location below each of the core holes such that the drain hole communicates with the core hole.

4. The Braille block as set forth in claim 1, wherein the Braille block is laid on a sidewalk, thus being used as means for guiding a blind person to a place or enabling the blind to maintain a desired course.

5. The Braille block as set forth in claim 2, further comprising:
a drain hole formed in the block body at a location below each of the core holes such that the drain hole communicates with the core hole.

6. The Braille block as set forth in claim 2, wherein the Braille block is laid on a sidewalk, thus being used as means for guiding a blind person to a place or enabling the blind to maintain a desired course.
